(19) United States
(12) Patent Application Publication
(10) Pub. No.: US 2015/0215124 A1
(43) Pub. Date: Jul. 30, 2015

(54) Secure cryptographic method and suitable equipment

(71) Applicant: Michael Gude, Kerpen (DE)

(72) Inventor: Michael Gude, Kerpen (DE)

(21) Appl. No.: 14/544,614

(22) Filed: Jan. 28, 2015

(30) Foreign Application Priority Data
Jan. 29, 2014 (DE) DE102004000996.3

(51) Int. Cl. H04L 9/08; G06F 7/58

(52) U.S. Cl. CPC H04L 9/0869; H04L 9/0816; G06F 7/588; H04L 2209/24

(57) ABSTRACT

The present invention relates, generally, to an encryption and decryption system, and, more particularly, to an encryption system utilizing a one-time pad key.

The task of the invention is to create a practically feasible 100% secure encryption process that is convenient to use.

A random numbers generator or random bit generator of outstanding quality is used. Such ideal chances will then be recorded on a data storage device for later encryption purposes. It is important in the context that said storage device would be kept in a safe place or, in the case of encrypted data transmission, would be physically delivered to the recipient via a trustworthy transmission route.

Since a secure encryption is only assured if the key or keys is/are used only a single time, it will be expedient, for information to be recorded on the basis of the keys used. Only in this case the one-time pad key can be found again for decryption.

For decryption the formerly recorded key is used. Due to the kind of encryption used the recorded key may first be decrypted itself before using the symmetrical encryption/decryption method.

### TECHNICAL FIELD

The present invention relates, generally, to an encryption and decryption system, and, more particularly, to an encryption system utilizing a one-time pad key.

### BACKGROUND OF THE INVENTION

For many years, it has been very problematic to encrypt data in such a way that they could not be decrypted by an unauthorised addressee or an interceptor, whilst enabling the authorised addressee to decrypt said data into the original legible version.

All the known schemes based on mathematical processes have two striking disadvantages:

1. There has so far been no mathematical proof for the security of such schemes. The fact is that customary processes are based on the complexity of computing large prime numbers or the roots of very big numbers.

2. The existing schemes are vulnerable to being cracked by means of powerful computers so that in the course of time ever longer keys have been employed.

Discomfort has been caused, in particular, by knowing that it was possible for any data considered as undecipherable today being deciphered in just a few years' time. Thus, data recorded by the secret services and others today may be completely deciphered in the near future.

There exists, however, one method that is 100% impregnable where a decryption will not be possible even in the distant future. It involves the use of symmetric single-use keys. Each one of such keys has the following qualities:

1. It comprises a sequence of completely random numerals or bits.

2. It really must be used only once for an encryption job.

3. The key has exactly the same length as the data to be encrypted.

The reason for such a scheme not having been used until now has been the lack of affordable random numbers generators with outstanding properties and the notion that the use of a key having the same length as the data would be impractical.

### SUMMARY OF THE INVENTION

The task of the invention is to create a practically feasible 100% secure encryption process that is convenient to use.

A random numbers generator or random bit generator of outstanding quality is used. Such ideal chances will then be recorded on a data storage device for later encryption purposes. It is important in the context that said storage device would be kept in a safe place or, in the case of encrypted data transmission, would be physically delivered to the recipient via a trustworthy transmission route.

Since a secure encryption is only assured if the key or keys is/are used only a single time, it will be expedient, for information to be recorded on the basis of the keys used. Only in this case the one-time pad key can be found again for decryption.

For decryption the formerly recorded key is used. Due to the kind of encryption used the recorded key may first be decrypted itself before using the symmetrical encryption/decryption method (alternative [7]).

### BRIEF DESCRIPTION OF DRAWINGS

The drawings show exemplary embodiments for the encryption and decryption processes:

FIG. 1: A system and method for encryption

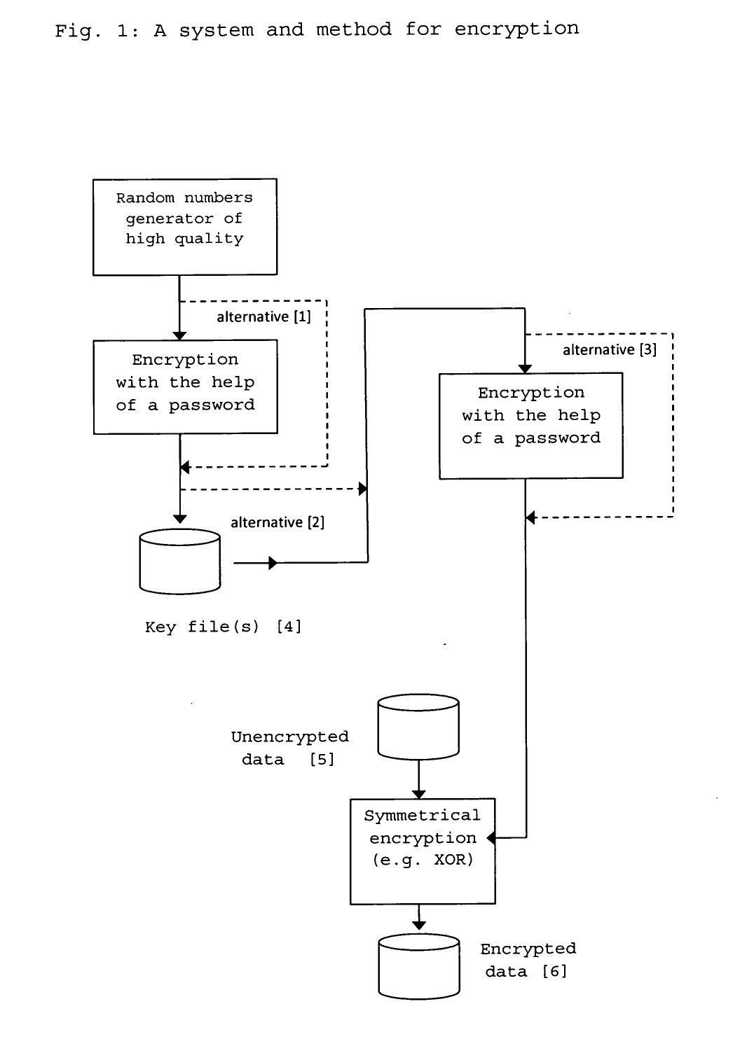

FIG. 2: A system and method for decryption

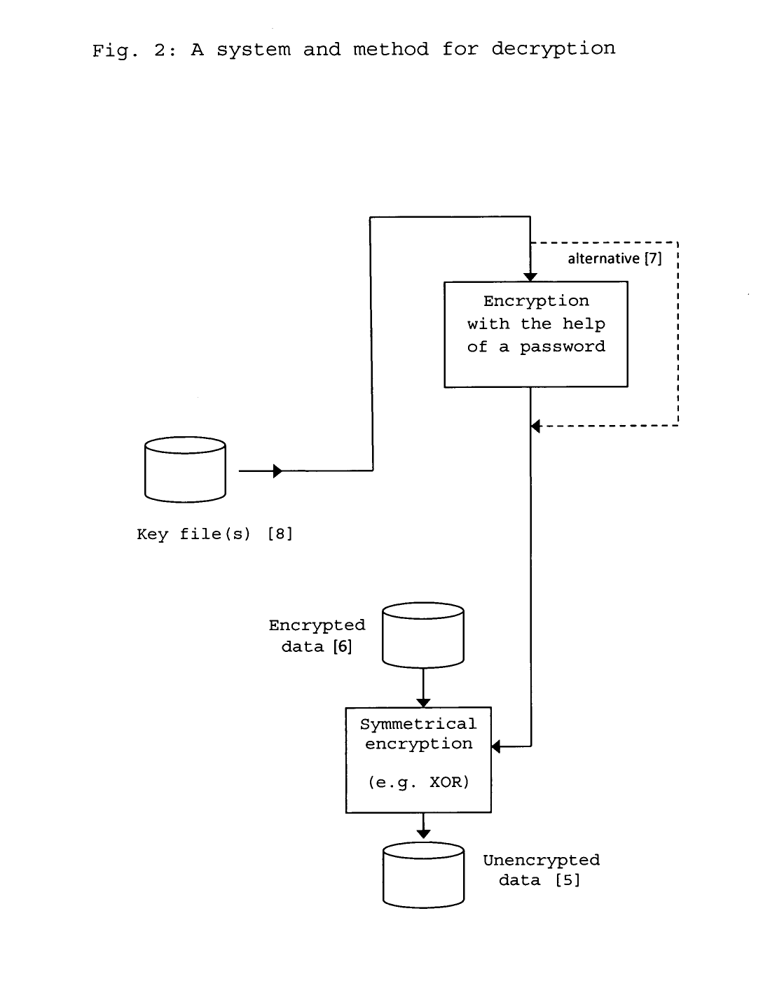

### DETAILED DESCRIPTION OF THE INVENTION

A random numbers generator of high quality is used to generate a full random bit stream. Generators that are particularly suitable for such a purpose are those using chance phenomena such as transistor noises, radioactive disintegration, or phase jitters of a semiconductor circuit. Such ideal chances will then be recorded on a data storage device for later encryption purposes as key files [4].

To tighten security even further, the random data can prior to storage be modified pursuant to claim 3 by using a password and an encryption method of prior art (alternative [1]).

It is important in the context that said storage device would be kept in a safe place or, in the case of encrypted data transmission, would be physically delivered to the recipient via a trustworthy transmission route.

Since a secure encryption is only assured if the key or keys is/are used only a single time, it will be expedient, for information to be recorded on the basis of the keys used. Only in this case the one-time pad key can be found again for decryption.

In addition or alternatively, the keys read for encrypting by the data storage device can be modified pursuant to claim 4 (alternative [3]). Such a modification of the key or keys can be effected, pursuant to claim 5, by means of traditional encryption by password.

Depending on the type of modification, there will be a need, in addition to the key or keys, for one or two password/s, without which no decryption will be possible.

The key or keys that may have been modified in such a manner will then be linked with the unencrypted data [5] by means of a symmetrical encryption method, most easily by using the XOR operation, and this will produce the encrypted data [6]. In addition to the encrypted data, a few more details will have to be filed which will facilitate re-identifying and using the correct key for the decryption process. For this purpose, an identifier for finding the key as well as the selected modification steps of the key must be secured. Pursuant to claim 6, such information can be recorded, either alternatively or cumulatively, on the data file holding the key or keys, on the data file holding the encrypted data, or on a third data storage device.

Another advantage of this scheme is that pursuant to claim 7 the user of the system does not personally have to operate a random number generator but can merely use a suitable data storage medium with the random data. Nowadays, small portable hard disks with 2-TByte storage capacity are already available at reasonable prices. However, in that case, the risk of key data being copied in transit cannot be completely ruled out.

The requirements for the decryption process include, in addition to the key or keys, one or two password/s, depending on the degree of modification, and of course the data to be decrypted.

If these data and the information about the key to be used are available, the decryption of the data can be effected by the same procedure as the encryption (e.g. by XOR operation).

Since a secure encryption is only assured if the key or keys is/are used only a single time, it will be expedient pursuant to claim 2, for information to be recorded on the basis of the keys used.

To tighten security even further, the random data can prior to storage be modified pursuant to claim 3 (alternative [1]). In addition or alternatively, the keys read for encrypting by the data storage device can be modified pursuant to claim 4 (alternative [3]). Such a modification of the key or keys can be effected, pursuant to claim 5, by means of traditional encryption by password.

Depending on the type of modification, there will be a need, in addition to the key or keys, for one or two password/s, without which no decryption will be possible.

The key or keys that may have been modified in such a manner will then be linked with the unencrypted data [5] by means of a symmetrical encryption method, most easily by using the XOR operation, and this will produce the encrypted data [6]. In addition to the encrypted data, a few more details will have to be filed which will facilitate re-identifying and using the correct key for the decryption process. For this purpose, an identifier for finding the key as well as the selected modification steps of the key must be secured. Pursuant to claim 6, such information can be recorded, either alternatively or cumulatively, on the data file holding the key or keys, on the data file holding the encrypted data, or on a third data storage device.

Another advantage of this scheme is that pursuant to claim 7 the user of the system does not personally have to operate a random number generator but can merely use a suitable data storage medium with the random data. Nowadays, small portable hard disks with 2-TByte storage capacity are already available at reasonable prices. However, in that case, the risk of key data being copied in transit cannot be completely ruled out.

The requirements for the decryption process include, in addition to the key or keys, one or two password/s, depending on the degree of modification, and of course the data to be decrypted.

If these data and the information about the key to be used are available, the decryption of the data can be effected by the same procedure as the encryption (e.g. by XOR operation).

A decryption of the data without a key is impossible with 100% certainty.

If the quantity of data is not excessive, the procedure can pursuant to claim 8 be accomplished with the use of a USB stick or a portable hard disk with a small form factor, which facilitates its use in connection with portable computers.

Even tighter security can be attained when the random number generator is operated directly at the user's location and the key or keys can be used directly pursuant to claim 9 (alternative [2]). In this case, it will however be necessary to record the key data for later decryption.

1. A system for the encryption and decryption of data comprising a random numbers generator of high quality, at least one data storage medium for the key or modified key and a symmetrical encrypting method, characterised in
that the key or keys being generated by the random numbers generator and recorded on the data storage medium, and by the information about the key employed for an unencrypted file being recorded to facilitate later re-identification for decryption purposes.

2. A method according to claim 1, characterised in
that information about the random numbers already used being recorded to prevent multiple use of a key.

3. The method according to one or more of the preceding claims
characterised in
that the recorded key being modified prior to it being written into the storage medium.

4. The method according to one or more of the preceding claims
characterised in
that the symmetrical encryption process only being accomplished by a modified key, whereby said modified key is generated by the key read from the storage medium.

5. The method according to one or more of the preceding claims
characterised in
that the modification of the key being effected by a known encryption method with the help of a password.

6. The method according to one or more of the preceding claims 1 to 5,
characterised in
that the information about the key used for an unencrypted file and/or the key usage being recorded
on the data carrier where the key or modified key is also held and/or
on the data carrier where the encrypted data are filed and/or
on another data carrier.

7. The method according to one or more of the preceding claims
characterised in
that the key or modified key being recorded on a portable data carrier, e.g. so that the recording can take place at a location and/or a time completely divorced from the actual encryption or decryption processes.

8. The method according to one or more of the preceding claims
characterised in
that a USB stick or a portable hard disk with a small form factor being used as a data storage medium.

9. The method according to one or more of the preceding claims
characterised in
that the data used for the encryption coming directly from a random numbers generator and only these being recorded, in modified or unmodified form, for later decryption.

10. A device for realising the method according to one or more of the preceding claims
characterised in
that the use of a computer, a random numbers generator and at least one storage medium.
